(19) United States
(12) Patent Application Publication
(10) Pub. No.: US 2006/0096964 A1
(43) Pub. Date: May 11, 2006

(54) Method and apparatus for breakthrough detection for laser workpiece processing operations

(76) Inventor: Craig A. Fordahl, Loretto, MN (US)

Correspondence Address: James W. Miller, Foshay Tower, Suite 1005, 821 Marquette Avenue, Minneapolis, MN, 55402, US

(21) Appl. No.: 10/983,955

(22) Filed: Nov. 8, 2004

(51) Int. Cl. B23K 26/38; B23K 26/03

(52) U.S. Cl. 219/121.83; 219/121.71

(57) ABSTRACT

An apparatus for breakthrough detection in laser workpiece processing operations performed by a pulsed laser. The breakthrough detection apparatus comprises a video camera that receives and senses returned radiated light energy from a target area on the workpiece each time the pulsed laser beam strikes the target area and vaporizes some of the material of the workpiece. The camera output signal from the video camera is fed to a breakthrough detection processor that compares the level of the camera output signal, which is proportional to the intensity of the returned radiated light energy received by the video camera, to a predetermined threshold. A breakthrough detection signal is generated by the breakthrough detection processor when the level of the camera output signal falls below the predetermined threshold due to the fact that workpiece breakthrough has occurred and little if any material remains to be vaporized by the pulsed laser beams. If desired, additional pulsed laser beams can be issued after breakthrough detection for hole cleanup purposes.

### TECHNICAL FIELD

This invention relates to workpiece processing operations, such as drilling or cutting operations, using a pulsed laser. More particularly, this invention relates to a method and apparatus for breakthough detection during such operations, i.e. for detecting when the laser has penetrated through the thickness of the workpiece.

### BACKGROUND OF THE INVENTION

Laser machine tool systems are often used for workpiece processing operations such as drilling and cutting. In such operations, it is common to use a pulsed laser directed at a target area on the workpiece. Each time the laser is pulsed, i.e. each time the laser emits a beam, it creates and then deepens a hole at that area until the hole breaks through the workpiece thickness after a sufficient number of pulsed laser beams. The formation of such a hole is the final objective in a drilling operation but only the first step in a cutting operation. After the hole is formed during a cutting operation, the laser and the workpiece are then moved relative to one another to begin cutting a line in the workpiece during successive pulsed laser beams.

The thickness and hardness of the workpiece being processed can vary somewhat between different workpieces or between different locations on the same workpiece. In addition, the power output of the laser can vary over time. Consequently, the number of pulsed laser beams required to achieve breakthrough can vary from hole to hole. One hole could be formed in as few as three or four pulsed laser beams. Another hole might require six or seven pulsed laser beams.

As a result, one known practice in the art is to program the laser to fire a sufficient number of pulsed laser beams to breakthrough the workpiece under worst case conditions. This means of course that holes which require fewer pulsed laser beams will have additional, unnecessary pulsed laser beams directed at them after they have already been formed. This can damage the worktable or fixture underlying the workpiece and/or can damage the edges or sidewalls of the hole. In addition, some workpieces, such as airfoil shaped turbine blades, have two surfaces in close proximity with only the first surface requiring a hole. If unnecessary pulses are directed at such first surface after the hole is formed in the first surface, such pulses can easily pass through the hole and then hit and damage the second or backwall surface.

Even when such damage is avoided, firing unnecessary pulsed laser beams increases the workpiece processing time, thereby leading to a reduction in the output of the workpiece processing operation, i.e. fewer workpieces are processed per unit of time. Accordingly, it would obviously be desirable to avoid such damage and to increase output if possible.

Some suggestions have been made for improving laser workpiece processing operations by detecting when workpiece breakthrough occurs. U.S. Pat. No. 5,026,979 discloses optical sensors, such as photodiodes, for this use. The output of the optical sensors is used to determine how long it takes to breakthrough the workpiece being processed. Adjustments to the laser processing components can be made if the breakthrough time exceeds a predetermined threshold.

Other breakthrough detectors are disclosed in U.S. Pat. Nos. 5,045,669, 5,059,761, 6,140,604, European Patent 0,937,533 and Japanese Patent 08057669.

While breakthrough detectors have been disclosed for use in laser workpiece processing operations, such detectors use specialized sensors and the like added to an existing laser machine tool system. Such sensors can be expensive. In addition, such sensors are often mounted externally to the optical path in proximity to the area where the laser beam is focused on the workpiece. Special mountings must be provided and the sensors or their mountings are exposed to contamination from the processing operation. It would be an advantage to have a breakthrough detection apparatus using common, readily available and inexpensive components, and which is located somewhat removed from the contaminants generated by the workpiece processing operation.

### SUMMARY OF THE INVENTION

One aspect of this invention relates to a method of breakthrough detection in laser workpiece processing operations. The method comprises sequentially directing a series of pulsed laser beams at a target area of the workpiece and sensing returned radiated light energy from the target area after the pulsed laser beams strike the target area using a video camera. The method then comprises comparing the returned radiated light energy sensed by the video camera from the target area to a predetermined energy threshold. Finally, the method comprises determining that workpiece breakthrough has occurred when the comparing step finds that the returned radiated light energy sensed by the video camera has fallen below the predetermined energy threshold.

Another aspect of this invention relates to an apparatus for breakthrough detection of a workpiece being processed by a pulsed laser of a laser machine tool system, the laser providing a series of pulsed laser beams that are focused on a target area on the workpiece, each pulsed laser beam when striking the target area creating an energy plume containing light energy when the target area has material capable of being vaporized by the laser beam. The breakthrough detection apparatus of this invention comprises a video camera that senses the returned radiated light energy in the energy plume and that provides a camera output signal that is proportional to the intensity of the returned radiated light energy received by the video camera. In addition, breakthrough detection logic is provided that receives the camera output signal from the video camera. The breakthrough detection logic generates a breakthrough detected signal using the camera output signal.

Yet another aspect of this invention relates to a method of operating a laser machine tool system for laser workpiece processing operations. The laser machine tool system incorporates a video camera that is directed at a target area on the workpiece. The method comprises sequentially directing a series of pulsed laser beams at a target area of the workpiece and using the video camera to sense returned radiated light energy from the target area after the pulsed laser beams strike the target area.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a block diagram illustrating an apparatus according to this invention installed on a typical laser machine tool system, the apparatus detecting workpiece breakthrough in laser workpiece processing operations; and

FIG. 2 is a plan view of a display monitor screen that is part of the laser machine tool system with which the breakthrough detection apparatus of FIG. 1 is used, particularly illustrating the timing of various steps of the method of breakthrough detection, as performed by the breakthrough detection apparatus of FIG. 1, during a single breakthrough detection cycle.

### DETAILED DESCRIPTION

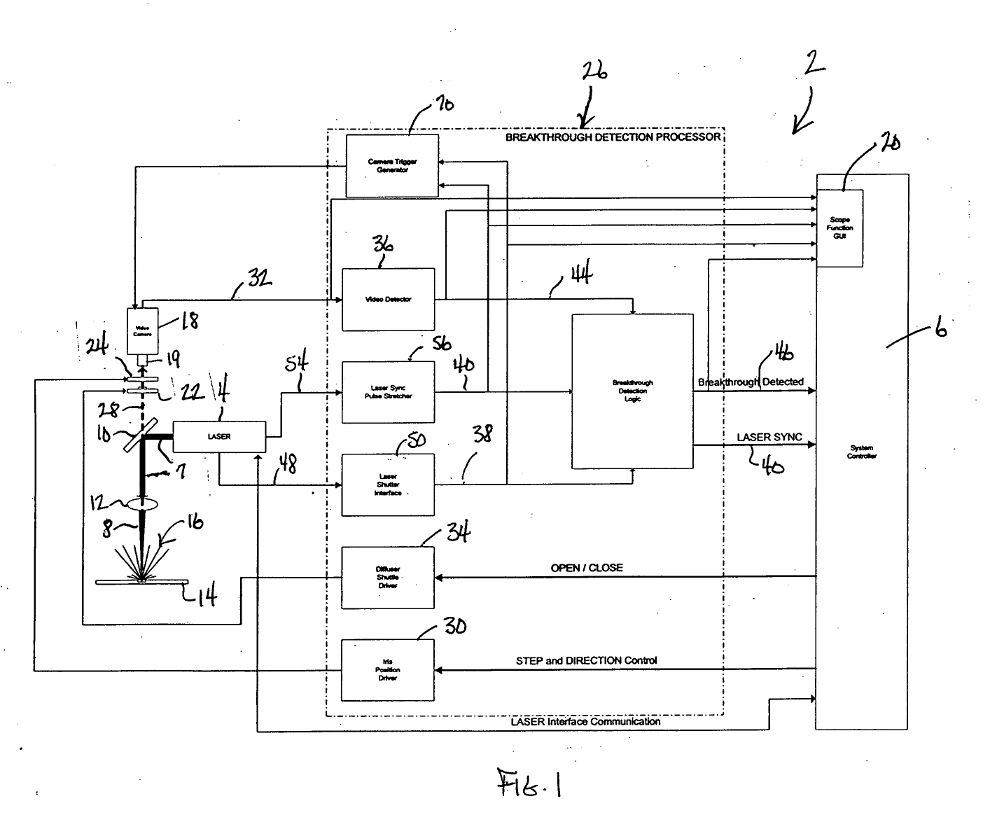

FIG. 1 is a block diagram which illustrates, among other things, the major components of a typical laser machine tool system 2 for laser workpiece processing operations. Laser machine tool system 2 comprises a conventional pulsed Nd:YAG laser 4 operatively connected to and controlled by a typical CNC system controller 6. Laser 4 will emit a series of pulsed laser beams 7 having a programmed duration and at a programmed rate as commanded by system controller 6. Each pulsed laser beam 7 emitted from laser 4 is reflected by one or more mirrors, one of which is a dichroic mirror 10, through a focusing lens 12 that provides a focused pulsed laser beam 8 on a target area on a workpiece 14 being processed.

Workpiece 14 may be made of any suitable material. Workpiece 14 will be supported on a suitable fixture or worktable (not shown).

FIG. 1 illustrates a single pulsed laser beam 8 focused on and striking a target area on workpiece 14. Pulsed laser beam 8 heats workpiece 14 in the target area and vaporizes some of the material comprising workpiece 14. The process of heating the material of workpiece 14 to vaporization temperature causes the heated area of workpiece to radiate light energy, both in and outside the visible spectrum. This radiated light energy is represented by the upwardly directed energy plume 16 shown in FIG. 1 issuing from the target area of workpiece 14. When a sufficient number of pulsed laser beams 8 strike the same target area of workpiece 14, the thickness of workpiece 14 is penetrated and a hole is formed in workpiece 14.

In many conventional laser machine tool systems 2, a CCTV (Closed Circuit Television) video camera 18 is typically already present for the purpose of viewing workpiece 14. For example, video camera 18 can be used by the system operator to visually locate a scribe line or other mark on workpiece 14 to enable laser 4 to be focused on a desired target area. The video output of video camera 18 can be displayed on a monitor 20 that comprises part of a graphical user interface on system controller 6. Monitor 20 could also comprises a stand alone monitor.

Video camera 18 is coaxially aligned with pulsed laser beam 8 as pulsed laser beam 8 is directed at the target area of workpiece 14. See FIG. 1 which illustrates the coaxial alignment of video camera 18 with pulsed laser beam 8 after the laser beam 7 emitted by laser 4 has been reflected by dichroic mirror 10 at the target area of workpiece 14. Dichroic mirror 10, which is also a standard component in many conventional laser machine tool systems 2, is coated to reflect the wavelength of laser beam 7 and to transmit shorter wavelengths, including the wavelengths sensed by video camera 18.

This invention utilizes video camera 18, which is already present in many laser machine tool systems, as part of a novel method and apparatus for breakthrough detection. In addition to video camera 18, one embodiment of this invention also includes an adjustable iris 22 and a light diffuser 24 positioned in the optical path between the target area of workpiece 14 and the lens 19 of video camera 18. In addition, a breakthrough detection processor 26 is provided which is connected, as will be described hereafter, to various of the components of laser machine tool system 2, including to video camera 18. Video camera 18 can be an STC-730 video camera made by Sensor Technologies America, Inc.

Breakthrough detection processor 26 is embodied in any suitable circuit contained on a circuit board or the like. In addition, breakthrough detection processor could be a portion of the hardware and software in system controller 6 (e.g. a logic chip within controller 6) with video camera 18 being connected to system controller 6 using firewire, bluetooth or some other video digital transmission method. This invention takes advantage of the fact that video camera 18 can act as an optical sensor and can receive and detect the returned radiated light energy 28 contained in energy plume 16 that is generated each time a pulsed laser beam 8 strikes workpiece 14.

Adjustable iris 22 is used during setup to set the exposure level of video camera 18 to prevent video camera 18 from being oversaturated by light energy 28 being returned to video camera 18. System controller 6 adjusts the aperture setting of iris 22 through an iris position driver 30 contained in breakthrough detection processor 26. Basically, the operator will adjust the size of iris 22 by trial and error depending upon how much light energy is given off by a particular material being processed at a particular power setting for laser 4 to prevent the imaging sensor in video camera 18 from being oversaturated by light energy 28 from energy plume 16. If oversaturation occurs for a workpiece 14 made of a particular material at a particular laser power setting, the operator will make iris 22 smaller until oversaturation disappears and video camera 18 provides a usable camera output signal 32.

Once a setting for iris 22 is established, it will often remain constant during subsequent laser workpiece processing operations for the particular material and for the same power settings for which the iris setting was developed. In this situation, iris 22 is adjusted only during setup and not during breakthrough detection itself during subsequent laser workpiece processing operations on the same type of material and at the same laser power settings. However, the setting of iris 22 can vary from hole to hole when conditions warrant. In addition, an alternative to adjustable iris 22 for adjustably restricting the returned radiated light energy 28 is an LCD attenuator.

Light diffuser 24 is a piece of material comprising sandblasted or speckled plexiglas or plastic or the like. Light diffuser 24 spatially and chromatically diffuses or homogenizes returned radiated light energy 28 to give a more uniform energy distribution over the imaging sensor of video camera 18.

Light diffuser 24 is used only during breakthrough detection and not when video camera 18 is being used by the operator for normal visual observation of workpiece 14. In this latter event, light diffuser 24 would interfere with such visual observation and must be removed from the optical path between workpiece 14 and video camera 18. Accordingly, light diffuser 24 is carried on a driven carrier or shuttle (not shown) that is moved by a powered actuator such as an air solenoid or motor. This allows light diffuser 24 to be extracted from the optical path to video camera 18 when it is necessary for the operator to view an image of workpiece 14 using video camera 18. System controller 6 actuates the driven shuttle to move light diffuser 24 into and out of the optical path to video camera 18 using a diffuser shuttle driver 34 in breakthrough detection processor 26.

Camera output signal 32 is a DC coupled RS-170 or RS-170a analog signal that is sent to a video detector 36 in breakthrough detection processor 26. The amplitude of camera output signal 32 depends on the exposure level of the imaging sensor in video camera 18. The higher the exposure level, i.e. the higher the intensity of light energy 28 being returned to the imaging sensor, the higher the amplitude of camera output signal 32. The DC coupled camera output signal 32 keeps the signal level from shifting when video camera 18 receives a returned radiated light energy 28 which signal level would otherwise shift when AC coupled because of a change in the average voltage. Both the DC coupling of camera output signal 32 and light diffuser 24 collectively aid in delivering a more uniform camera output signal 32 to breakthrough detection processor 26 for more reliable breakthrough detection.

The method of breakthrough detection of this invention embodied in the operation of the apparatus of this invention will now be described. Whenever pulsed laser beam 8 strikes the target area of workpiece 14, a portion of the light energy contained in energy plume 16 is collected by the focusing lens 12 and returned through dichroic mirror 10 (which is coated to transmit wavelengths shorter than the wavelength of laser beam 8), through iris 22, through light diffuser 24 and finally to the imaging sensor of video camera 18. This happens each time a pulsed laser beam 8 strikes the target area of workpiece 14 and an energy plume 16 is created. After laser beam 8 breaks through workpiece 14, there is very little material at the focal point of laser beam 8 to absorb laser beam 8 and therefore very little returned radiated light energy 28 is returned to video camera 18. This invention detects the change in returned radiated light energy 28 to determine when breakthrough has occurred.

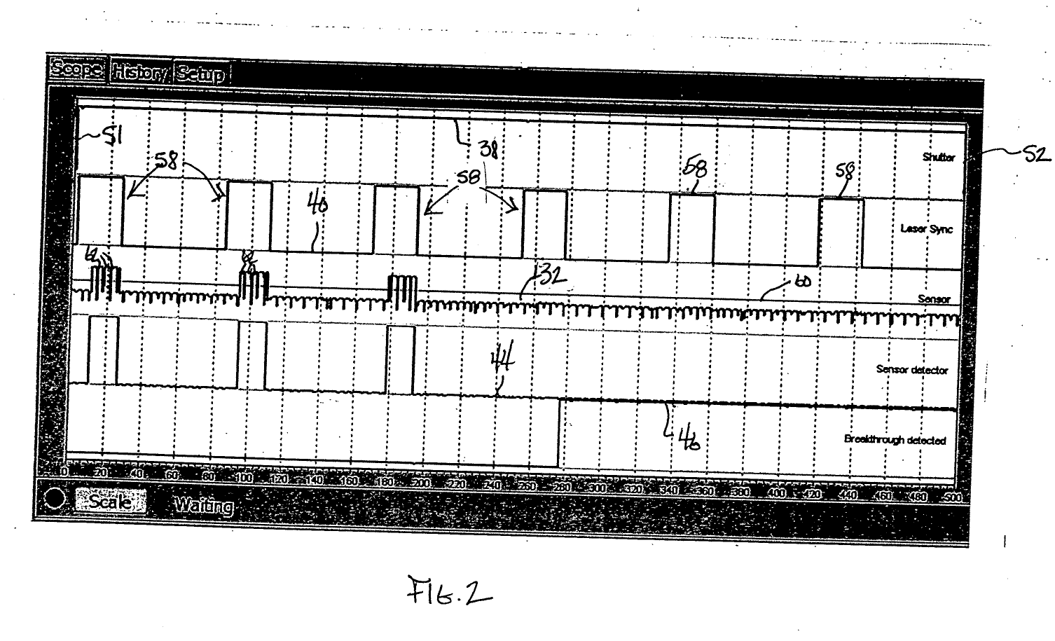

FIG. 2 depicts a breakthrough detection cycle from start to finish. FIG. 2 is a depiction of what can be actually seen or displayed to the operator on display monitor 20 of the graphical user interface during a single breakthrough detection cycle. Five pieces of data or information are displayed along the y axis comprising from top to bottom:
a laser shutter signal 38 that marks the beginning and end of the breakthrough detection cycle,
a laser sync signal 40 that comprises a plurality of stretched laser sync pulses as will be explained hereafter, the camera output signal 32 from video camera 18,
a sensor detector signal 44 that is periodically set or not depending upon whether or not camera output signal 32 is above or below a predetermined threshold 60,
and a breakthrough detected signal 46 that is generated when breakthrough of workpiece 14 has been achieved. Time is displayed along the x axis. Thus, FIG. 2 also represents a timing diagram for the operation of the five items displayed along the y axis during a single breakthrough detection cycle.

A breakthrough detection cycle is initiated when system controller 6 commands the shutter (not shown) of laser 4 to open to enable laser 4 to thereafter fire a series of pulsed laser beams 8 having a predetermined duration and at a predetermined frequency. When the shutter of laser 4 opens, laser 4 sends a shutter status signal 48 to breakthrough detection processor 26. Shutter status signal 48 from laser 4 goes through an optically isolated input and a digital filter in a laser shuttle interface 50 to generate the conditioned laser shutter signal 38. Conditioned laser shutter signal 38 removes a logic reset from breakthrough detection logic 54 contained in breakthrough detection processor 26, thereby starting the breakthrough detection cycle.

The leading edge 51 of laser shutter signal 38, which begins the breakthrough detection cycle, is shown on the far left in FIG. 2. The trailing edge 52 of laser shutter signal 38, which terminates the breakthrough detection cycle, is shown on the far right in FIG. 2.

Laser 4 generates an electronic sync pulse 54 that is synchronized with each pulsed laser beam 7 emitted from laser 4. Sync pulse 54 from laser 4 is a very short pulse equal in duration to the duration of pulsed laser beam 8, typically 0.3 mS.-5 mS. Such a short sync pulse 54 is shorter than the time required by video camera 18 to capture light energy 28 and provide camera output signal 32. Therefore, a laser sync pulse stretcher 56 in breakthrough detection processor 26 creates an elongated or stretched laser sync pulse 58 that lasts long enough for camera output signal 32 from video camera 18 to be received and processed by breakthrough detection processor 26. Laser sync signal 40 shown in FIG. 2 shows a plurality of stretched laser sync pulses 58 in a single breakthrough detection cycle, each stretched laser sync pulse 58 being triggered by the leading edge of each sync pulse 54 output by laser 4.

Video detector 36 in breakthrough detection processor 26 is a comparator that compares camera output signal 32 to a predetermined threshold level 60. See FIG. 2. That comparison is done only towards the end of each stretched laser sync pulse 58, i.e. over the portion of stretched laser sync pulse 58 adjacent the trailing edge of stretched laser sync pulse 58. Camera output signal 32 has a plurality of positive transitions 62 caused by the horizontal sync pulse timing of video camera 18. These positive transitions 62 are indicated by the serrations in the positive voltage of camera output signal 32 as shown on the third line in FIG. 2. In effect, camera output signal 32 in the third line in FIG. 2 does not illustrate a continuous voltage representative of the returned radiated light energy 28, but instead comprises a series of voltage snapshots of the returned radiated light energy 28 taken over time.

In any event, when video detector 36 detects the first transition 62 contained in camera output signal 32 that is above the threshold level, video detector 36 outputs sensor detector signal 44 to breakthrough detection logic 54. Sensor detector signal 44 is represented by the fourth line in FIG. 2. Sensor detector signal 44 is cleared on the trailing edge of each stretched laser sync pulse 58. Note how sensor detector signal 44 disappears at the conclusion of each stretched laser sync pulse 58. If breakthrough detection logic 54 has received a sensor detection signal 44 by the time the trailing edge of each stretched laser sync pulse 58 is detected, this means that sufficient returned radiated energy was received by video camera 18 to indicate that workpiece 14 has not yet been broken through by pulsed laser beam 8.

However, at some point, breakthrough of workpiece 14 will occur. When this happens, video detector 36 will not detect any positive transitions 62 in camera output signal 32 above the threshold level. Thus, at the trailing edge of that particular stretched laser sync pulse 58, breakthrough detection logic 54 will output breakthrough detected signal 46 to system controller 6. Breakthrough detected signal 46 is shown in the fifth and last line of FIG. 2.

Thus, in the breakthrough detection cycle shown in FIG. 2, during the first three pulsed laser beams 8 striking workpiece 14, camera output signal 32 from video camera 18 was seeing enough radiated returned light energy 28 that the voltage representing such energy 28 was above the threshold level. But, workpiece breakthrough occurred at the conclusion of the third pulsed laser beam 8 or at the very beginning of the fourth laser beam. Thus, during the fourth pulsed laser beam 8, insufficient returned radiated light energy 28 was received by video camera 18 and breakthrough detection logic 54 was able to then output breakthrough detected signal 46 to system controller 6. Obviously, in other breakthrough detection cycles, breakthrough might be detected after fewer or greater numbers of pulsed laser beams 8 have been fired at workpiece 14. FIG. 2 is only illustrative.

Each breakthrough detection cycle could end as soon as breakthrough detection signal 46 is generated by breakthrough detection logic 54 and is output to system controller 6. Thus, in the example of FIG. 2, the breakthrough detection cycle could have ended after the fourth stretched laser sync pulse 58. Such termination would occur by the closing of the shutter of laser 4 and the termination of laser shutter signal 38. A new breakthough detection cycle would then be initiated for processing of the next hole either in the same workpiece 14 or a new workpiece 14. Depending upon the workpiece 14 being processed, each workpiece 14 could be provided with anywhere from one hole to many holes.

However, each breakthrough detection cycle could be extended past the actual detection of breakthrough by allowing laser 4 to fire additional pulsed laser beams at workpiece 14. In the example shown in FIG. 2, two additional pulsed laser beams are shown being fired at workpiece 14 as indicated by the fifth and sixth stretched laser sync pulses 58 in laser sync signal 40 of FIG. 2. The number of such additional pulsed laser beams 8 can vary from one to any desired number of additional laser beams. Such additional pulsed laser beams can be used to ensure a clean breakthrough and to perform a hole clean up function.

In order to apply additional pulses past breakthrough detection as described above, system controller 6 must be able to count stretched laser sync pulses 58. Thus, laser sync signal 40 is also sent to system controller 6 for counting of the stretched laser sync pulses 58. System controller 6, executing a program written by a system programmer, then determines if certain programmed parameters of minimum, maximum or additional pulse requirements have been met. Under normal operating conditions of laser machine tool system 2, breakthrough detection would occur between the minimum and maximum number of pulses and system controller 6 would then allow the additional number of pulses that have been programmed to occur before closing the shutter of laser 4.

Using a minimum number of pulses can be desirable to avoid the problem of “false” breakthrough detection, i.e. the operator can program a minimum number of pulsed laser beams 8 be delivered even if breakthrough detection is signalled before the minimum number have been delivered. Similarly, the operator can program a maximum number of pulses. If breakthrough is not detected within the maximum number of pulses, then the laser machine tool system 2 will be shut down.

In setting the diameter of iris 22, the operator would use display monitor 20 of the graphical user interface to display the same type of breakthrough detection cycle as in FIG. 2, but over one or more test or setup laser beams fired at a sample workpiece. The goal would be to adjust the setting of iris 22 such that the returned radiated light energy 28 being picked up by video camera 18 and being output in camera output signal 32 lies slightly above the threshold level when the material has not yet been broken through. Thus, if in a first test beam 8, camera output signal 32 is wildly above or off scale relative to the threshold level, then the operator can close iris 22 in increments for future test beams 8 until camera output signal 32 looks much like that depicted under the first three stretched sync pulses 58 in FIG. 2.

Video camera 18 when operated normally generates a standard 60 hz field rate camera output signal 32 which is not precisely synchronized with the returned radiated light energy 28. Thus, video camera 18 operates asynchronously and provides a camera output signal 32 slightly behind the time when returned radiated light energy 28 is picked up by the imaging sensor of video camera 18.

However, it would be possible to precisely synchronize camera output signal 32 provided by video camera 18 to returned radiated light energy 28. This can be done with a camera trigger generator 70 in breakthrough detection processor 26 that monitors laser shutter signal 38. When laser shutter signal 38 is inactive indicating the shutter of laser 4 is closed, camera trigger generator 70 sends an internally generated 60 Hz trigger signal to video camera 18 causing video camera 18 to generate a standard 60 Hz field rate camera output signal 32 to allow video camera 18 to be used for normal image viewing. When laser shutter signal 38 is active indicating the shutter of laser 4 is open, camera trigger generator 70 uses laser sync signal 40 to generate the camera trigger signal. Synchronizing video camera 18 to laser sync pulses 58 when the shutter of laser 4 is open causes camera output signal 32 to be precisely timed to capture returned radiated light energy 28.

Various modifications of this invention will be apparent to those skilled in the art. Accordingly, the scope of this invention will be limited only by the appended claims.

I claim:

1. A method of breakthrough detection in laser workpiece processing operations, which comprises:
(a) directing a series of pulsed laser beams at a target area of the workpiece;
(b) sensing returned radiated light energy from the target area after the pulsed laser beams strike the target area using a video camera;
(c) comparing the returned radiated light energy sensed by the video camera from the target area to a predetermined energy threshold; and
(d) determining that workpiece breakthrough has occurred when the comparing step finds that the returned radiated light energy sensed by the video camera has fallen below the predetermined energy threshold.

2. The method of claim 1, further comprising the step providing an operator with the capability of directing a desired number of additional pulsed laser beam at the target area after determining that workpiece breakthrough has occurred.

3. The method of claim 1, further comprising the step of passing the returned radiated light energy through a light restricting device before reaching the video camera to prevent oversaturating the video camera with the returned radiated light energy.

4. The method of claim 3, wherein the light restricting device comprises an aperture, and further comprising the step of adjusting the size of the aperture during setup for a particular material of which the workpiece is made and for a particular power setting of the pulsed laser beams.

5. The method of claim 4, wherein the adjusting step comprises varying a diameter of an adjustable iris.

6. The method of claim 3, further comprising the step of passing the returned radiated light energy through a light diffuser before reaching the video camera.

7. The method of claim 1, further comprising the step of passing the returned radiated light energy through a light diffuser before reaching the video camera.

8. The method of claim 1, wherein the returned radiated light energy is in a visible light spectrum.

9. The method of claim 1, further comprising the step of aligning the camera coaxially with the pulsed laser beams and the target area on the workpiece.

10. The method of claim 1, wherein the sensing and comparing steps are performed each time a pulsed laser beam strikes the target area.

11. The method of claim 1, further comprising the steps of:
(a) generating a laser sync pulse each time a pulsed laser beam is fired;
(b) creating a stretched laser sync pulse having a longer duration that the laser sync pulse; and
(c) performing the comparing step in a trailing portion of the stretched laser sync pulse.

12. A method of operating a laser machine tool system for laser workpiece processing operations, the laser machine tool system incorporating a video camera that is directed at a target area on the workpiece, which comprises:
(a) directing a series of pulsed laser beams at a target area of the workpiece; and
(b) using the video camera to sense returned radiated light energy from the target area after the pulsed laser beams strike the target area.

13. The method of claim 12, further comprising the step of determining when workpiece breakthrough has occurred using the returned radiated light energy sensed by the video camera.

14. The method of claim 13, wherein the determining step comprises determining when the returned radiated light energy sensed by the video camera falls below a predetermined energy threshold.

15. The method of claim 12, further comprising the step of passing the returned radiated light energy through a light diffuser before reaching the video camera.

16. The method of claim 12, further comprising the step of also using the video camera to permit an operator to optically view the workpiece at times other than when the video camera is being used to sense returned radiated light energy.

17. The method of claim 16, further comprising the steps of:
(a) passing the returned radiated light energy through a light diffuser before reaching the video camera; and
(b) removing the light diffuser from an optical path between the target area and the video camera when the video camera is being used by the operator to optically view the workpiece.

18. An apparatus for breakthrough detection of a workpiece being processed by a pulsed laser of a laser machine tool system, the laser providing a series of pulsed laser beams that are focused on a target area on the workpiece, each pulsed laser beam when striking the target area creating an energy plume containing light energy when the target area has material capable of being vaporized by the laser beam, which comprises:
(a) a video camera that senses the returned radiated light energy in the energy plume and that provides a camera output signal that is proportional to the intensity of the returned radiated light energy received by the video camera; and
(b) breakthrough detection logic that receives the camera output signal from the video camera and generates a breakthrough detected signal using the camera output signal.

19. The apparatus of claim 18, further including a light diffuser contained in an optical path lying between the video camera and the target area to diffuse the returned radiated light energy being sensed by the video camera.

20. The apparatus of claim 19, wherein the light diffuser is carried on a movable shuttle to allow the light diffuser to be selectively inserted into or removed from the optical path.

21. The apparatus of claim 20, further including an adjustable light restricting device contained in an optical path lying between the video camera and the target area to provide an adjustable aperture through which the returned radiated light energy passes before reaching the video camera.
